(19) United States
(12) Patent Application Publication
(10) Pub. No.: US 2010/0273679 A1
(43) Pub. Date: Oct. 28, 2010

(54) METHODS FOR THE PREPARATION OF DNA MICROARRAYS WITH LINEAR HIGH DENSITY PROBES

(75) Inventors: Andrea Cuppoletti, Trento (IT); Francesco Stellacci, Somerville, MA (US); Harry Benjamin Larman, Falmouth, ME (US); Barbara Pisanelli, Foggia (IT)

Correspondence Address: DARBY & DARBY P.C., P.O. BOX 770, Church Street Station, New York, NY, 10008-0770, US

(73) Assignee: TWOF, INC, San Matteo (CA)

(21) Appl. No.: 12/677,798

(22) PCT Filed: Sep. 12, 2008
(86) PCT No.: PCT/EP2008/062207

§ 371 Date: Jul. 8, 2010

(30) Foreign Application Priority Data
Sep. 14, 2007 (IT) BO2007A000627

(51) Int. Cl. C40B 50/06

(52) U.S. Cl. 506/26

(57) ABSTRACT

A method for the realisation of DNA microarrays with linear high density probes, comprising a phase of replication of template DNA strands of a template microarray and a subsequent phase of stamping of the molecules obtained by replication on a substrate via the SuNS technique; the template strands (21, 38, 44) of said template microarray are either composed of or derived from a rolling circle (21; 38; 43).

### TECHNICAL FIELD

The present invention concerns a method for the preparation of DNA microarrays with linear high density probes.

### BACKGROUND ART

DNA microarrays are composed of immobilized single stranded DNA fragments of known nucleotide sequences.

Herein and hereinafter:
we refer to template strand as the strand immobilized to the DNA microarray surface which is used to generate the replica strand. DNA microarray composed of immobilized template strands is defined as the template DNA microarray
we refer to replica strand as the strand with complementary nucleotide sequence to template strand. The replica strand is generated by replication of the template strand via DNA polymerase.

The replica strands are transferred to the replica surface via the SuNS technique (Supramolecular Nano Stamping). SuNS is a molecular stamping technique for producing DNA microarray described and claimed in the patent application PCT WO2006112815 here incorporated by reference.

Specifically, this method is based on the production of replica strands by the replication of a template DNA strands of a microarray, and subsequently the stamping of these molecules on a new substrate by means of the SuNS technique as illustrated in FIG. 1. The DNA microarray, composed of immobilized replica strands is defined as the replica DNA microarray.
we refer to rolling circle as the circularized oligonucleotide where the 3′end and the 5′end of the single strand DNA are covalently attached. Rolling Circle Amplification (RCA) is driven by DNA polymerase and can replicate circular oligonucleotide strands under isothermal conditions (Lizzardi et. alt. Nature Genet. 1998, 19:225-232). Circularized DNA is present in nature as template for replication of genomic material in organisms such as viruses and bacteria (as plasmid DNA).

In this invention, the rolling circle is used either directly or indirectly as a template for the generation of repetitive units of probes that will be subsequently immobilized on a surface via SuNS stamping mechanism, thereby generating an array of repetitive units.

The use of a rolling circle will allow the generation of Linear High Density (LHD) strands that will permit the capture of multiple target sequences per strand. The density of probes will increase linearly with the cycles (n) of the replication/transcription of the original rolling circle.

DNA microarrays can be produced using a wide variety of technologies such as, for example, spotting on glass by means of pins with very fine points, photolithography with masks or with dynamic arrays of micromirrors, or electrochemical deposition on arrays of microelectrodes.

### DISCLOSURE OF INVENTION

The subject of the present invention is a method for the realisation of DNA microarrays with linear high density probes, comprising a phase of replication of template DNA strands of a template microarray and a subsequent phase of stamping of the molecules obtained by replication on a substrate by means of the SuNS technique; said method being characterised in that the template strands of said template microarray are composed of or derived from rolling circle.

In one embodiment, in the rolling circle replication operations, the rolling circle is fixed to a substrate and the replica strand is produced from a promoter strand complementary to a promoter sequence of said rolling circle and comprising a functional group suitable for guaranteeing subsequent fixing of the replica strand formed to a surface of a substrate.

In a second embodiment, said rolling circle is produced by closing of a purposely designed DNA strand, fixed to a substrate and comprising two separate halves of a ligation sequence; the DNA strand is closed by the action of a promoter strand which is complementary to the overall ligation sequence and comprises a functional group suitable for guaranteeing subsequent fixing of the replica strand formed on a surface of a substrate.

In a third embodiment, in the rolling circle replication operations a promoter strand is bound to a surface of a substrate and is extended by means of a rolling circle comprising a promoter sequence complementary to the promoter strand.

In a fourth embodiment, the replication of the rolling circle is done through a promoter in solution and the product of the extension of the promoter is subsequently bonded to the surface of the substrate to generate the template DNA microarray.

### BRIEF DESCRIPTION OF THE DRAWINGS

The following examples serve, for illustrative non-limiting purposes, to provide a better understanding of the invention with the help of the figures of the accompanying drawing, in which:

FIG. 1 illustrates in a simplified manner some phases of a method already used for the preparation of DNA microarrays in which the SuNS stamping technique is used;

FIG. 2 illustrates in a simplified manner some phases of the method of the present invention according to a first embodiment;

FIG. 3 illustrates in a simplified manner some phases of the method of the present invention according to a second embodiment;

FIG. 4 illustrates in a simplified manner some phases of the method of the present invention according to a third embodiment;

FIG. 5 shows the results of rolling circle preparation comparing in columns the 1 and 2 μM concentrations of each linear DNA length used;

FIG. 6 shows the results of rolling circle preparation comparing in columns the 4, 8 and 16 μM concentrations of each linear DNA length used;

FIG. 7 shows the results of rolling circle purification;

FIG. 8 shows the results of rolling circle amplification; and

FIG. 9 represents a slide on which the amplified sequences are spotted.

### BEST MODE FOR CARRYING OUT THE INVENTION

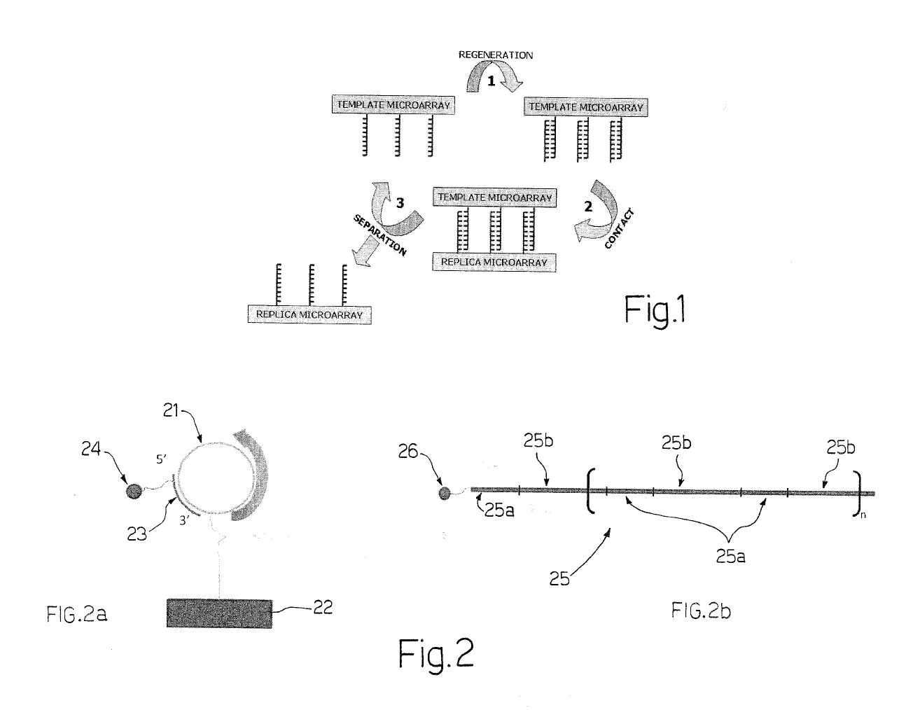

FIG. 2a shows a phase for realisation of the replica strands according to a first embodiment. A rolling circle 21 is bonded to a substrate 22 and comprises a promoter sequence and a probe sequence. A promoter strand 23 complementary to the promoter sequence is functionalised, preferentially but not exclusively, at its 5′ end with a functional group 24 suitable for guaranteeing subsequent fixing, covalent or non-covalent, of a replica strand formed by replication to the surface of a substrate for realisation of the replica DNA microarray by SuNS techniques.

Once the promoter strand 23 is bonded to the promoter sequence of the rolling circle 21 (FIG. 2a), it is extended by the action of a polyerase enzyme in the presence of deoxyribonucleotide triphosphates.

Once extension of the promoter strand 23 has been completed, a replica strand is obtained (not illustrated) which will be subsequently fixed to a substrate by means of its functional group 24 to obtain the replica DNA microarray according to the SuNS stamping technique.

Replication of the replica strand produces a linear high density probe 25 (FIG. 2b) (referred to below as LHD probe), which contains the replication n times of the rolling circle 21. In particular, the LHD probe 25 contains n times the alternation of the promoter sequence 25a and of the probe sequence 25b. The number n depends on the number of cycles performed in the replication phase via the Rolling Circle Amplification (RCA). In this way it is possible to obtain LHD probes 25 comprising of n number of probe sequences per strand and, therefore, increase efficiency, i.e. increase per unit area the ability to capture the target compared to the traditional DNA microarrays. The LHD probe obtained will necessarily contain a functional group 26 as required by the SuNS stamping technique.

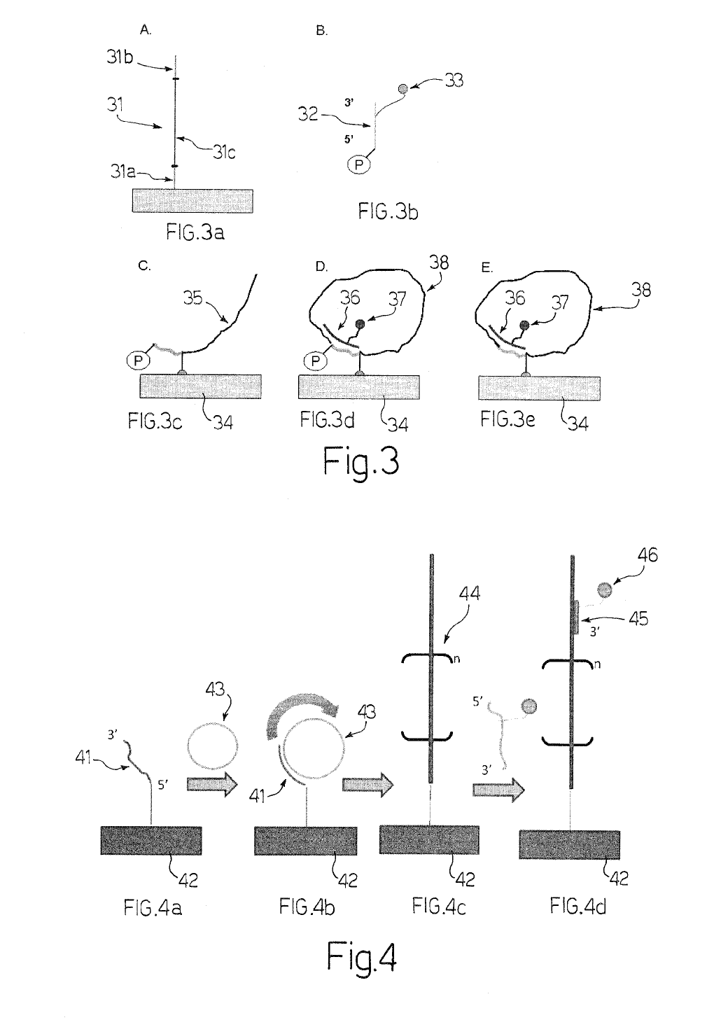

FIG. 3 shows the phases of a second embodiment of the method of the present invention, in which a rolling circle is realised by closing a specifically designed DNA strand.

Each rolling circle is prepared from a specifically designed DNA strand 31, which comprises two halves 31a and 31b of a ligation sequence. The two halves 31a and 31b are arranged on opposite sides of a probe sequence 31c (FIG. 3a). A promoter strand 32 having a 5′phosphorylated base (FIG. 3b) is extended on the strand 31 by replication. The promoter strand 32 is complementary to the half 31a and comprises a functional group 33 for subsequent fixing to the surface of a substrate 34. Once the replication has been completed, a strand 35 is obtained containing two halves of a ligation sequence complementary to the two halves 31a and 31b. The strand 35 thus obtained is transferred to a surface of the substrate 34 (FIG. 3c).

At this point, a ligation strand 36 is used consisting of the two halves 31a and 31b and comprising a functional group 37 for fixing to a substrate not illustrated.

The ligation strand 36 causes enzymatic closing of the strand (FIG. 3d). At this point, the rolling circle 38 is closed either via the action of a ligase or chemically and the replication process can be initiated (FIG. 3e), according to the phases described with reference to FIG. 2.

FIG. 4 illustrates the phases of a third embodiment of the method of the present invention. A complementary promoter strand 41 of the promoter sequence of a rolling circle is fixed to a substrate 42 so as to expose its 3′ end (FIG. 4a). A rolling circle 43 (FIG. 4b) is hybridized to the strand 41 which is extended by replication in the presence of the polymerase enzyme and deoxyribonucleotide triphosphates. Once a template strand 44 (FIG. 4c) with the required length has been obtained by replication, the rolling circle, the polymerase enzyme and the deoxyribonucleotide triphosphates are washed away. At this point the set of template strands obtained constitute a template DNA microarray on which the stamping is performed according to the SuNS technique as illustrated in FIG. 1 from replication of a promoter sequence 45 (FIG. 4d) comprising a functional group 46 as required by the SuNS technique.

A variation to this third embodiment described consists in bonding a new promoter sequence to the free end of the strand 44, using for the replication a promoter strand complementary to this new promoter sequence and comprising a functional group as required by the SuNS technique. In this way it is possible to guarantee replication of the entire strand 44, since the promoter strand from which the replication begins bonds with the strand 44 necessarily at its free end.

Spatial selectivity for production of strands of diverse nucleotide sequence is achieved preferentially, but not exclusively, by two methods. In the first method promoter strands have unique sequences and will hybridize with rolling circle of complementary sequence, therefore allowing for RCA of specific sequences in specific positions onto the surface of the array. In another method, the promoter sequence is fixed for all positions, and the spatial selection is achieved by use of spatial confinement of the promoter strands by wells generated on the surface or applied to the surface as a mean of a mask. The rolling circle DNA compromised by a common promoter sequence and a probe sequence of choice can be selectively deposited on the well of choice, containing the bound promoter sequence. The RCA step will generate strands of specific sequence at specific positions onto the surface of the substrate.

Experimental Part

—Preparation of Rolling Circle—

Two different lengths of oligonucleotides (60 and 80 nt) have been chosen for the rolling circle sequence, both with the same 20 mer-blunt ends sequence. The portion of the probe to amplify is respectively 40 and 60 nt long. The sequences have been designed to obtain a specific strand hybridization (Tm-GC content):

80-mer circle (5′ phosphorilated):
5′Pho-
ACTACATTCAATGCTCCATCGAAAGCCCCACCCGCCCAAATGTTTG
TCTGTGTTCCGTTGTCCGTGCTGTCAGAGTGTAC-3′
60-mer circle (5′ phosphorilated):
5′Pho-
ACTACATTCAATGCTCCATCGAAAGCCCCACCCGCCCAAATGTTTG
TCTGCAGAGTGTAC-3′
20-mer splint:
5′-TGAATGTAGTGTACACTCTG-3′
(Tm = 53,2 C; GC content = 40%)

T4 DNA ligase have been tested: 0.3 U/μl enzyme concentration and a ratio 1:1.5 between linear DNA and splint has been chosen in order to obtain an high yield of circular product, without concatameric secondary products.

Using this ratio, two DNA concentrations have been used:

1:1, 5 μM linear DNA/splint

2:3 μM linear DNA/splint.

The DNA mix (linear and splint) was added to the ligase buffer, heated at 90° C. for 10 min, then cooled down at RT for 1 h to allow strand hybridization; the ligase reaction was carried out at RT overnight.

The reaction solution has been purified using Bio Spin columns (BioRad) and by ethanol precipitation, and visualized by denaturant polyacrylamide-electrophoresis 10% (TBE-UREA).

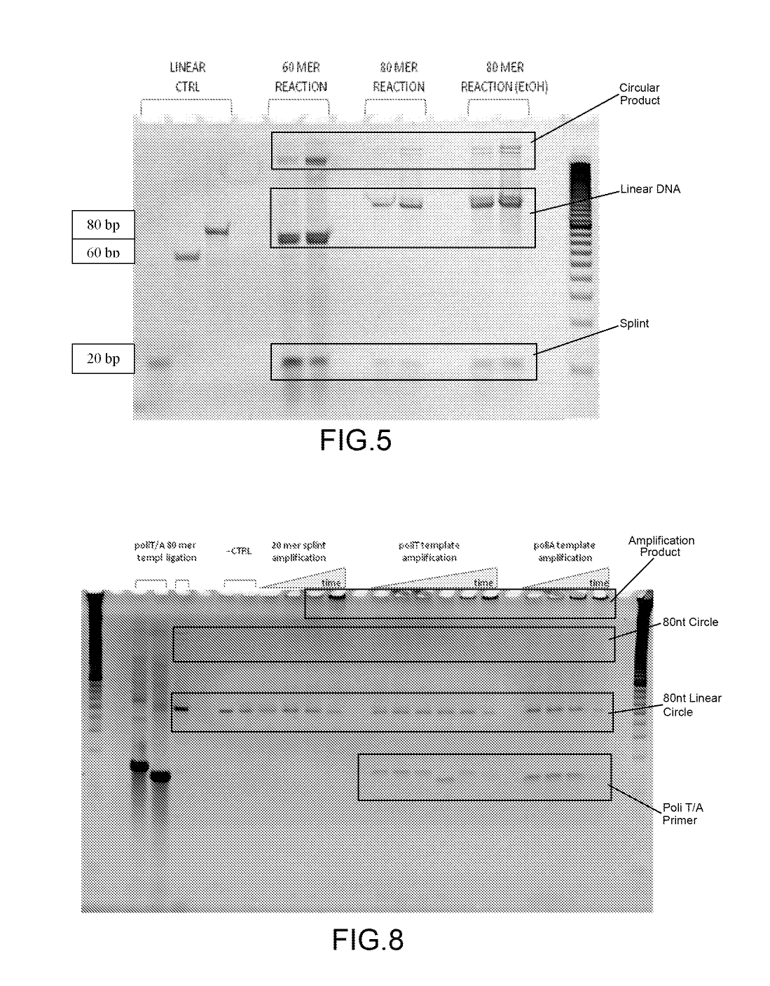

The following Table 1 and FIG. 5 summarize respectively the experimental conditions and results:

TABLE 1

| Linear DNA | Linear | Splint | | T4 ligase | |
|---|---|---|---|---|---|
| (length) | DNA (μM) | (μM) | | (U/μl) | purification |
| 60 (ctrl) | 1 μM | | | | |
| 80 (ctrl) | 1 μM | | | | |
| | | 1 | μM (ctrl) | | |
| 60 | 1 μM | 1.5 | μM | 0.33 | BioSpin |
| 60 | 2 μM | 3 | μM | 0.33 | BioSpin |
| 80 | 1 μM | 1.5 | μM | 0.33 | BioSpin |
| 80 | 2 μM | 3 | μM | 0.33 | BioSpin |
| 80 | 1 μM | 1.5 | μM | 0.33 | BioSpin EtOH |
| | | | | | precipitation |
| 80 | 2 μM | 3 | μM | 0.33 | BioSpin EtOH |
| | | | | | precipitation |

Compared to linear controls, all ligation products clearly show 3 separated bands, corresponding to the dehybridized splint, the unreacted linear oligo and the rolling circle; these bands are evident for both length and DNA concentration used.

The sample's collection after purification is not affected by the ethanol precipitation, allowing to collect more purified reaction product compared to BioSpin columns.

Following the same protocol, the experiment has been repeated increasing the DNA starting concentration, to obtain high yield of circular product

Table 2 summarizes the used concentrations.

TABLE 2

| LINEAR PRECURSOR | SPLINT | |
|---|---|---|
| CONCENTRATION (μM) | CONCENTRATION (μM) | RATIO |
| 4 | 6 | 1:1.5 |
| 8 | 12 | 1:1.5 |
| 16 | 24 | 1:1.5 |

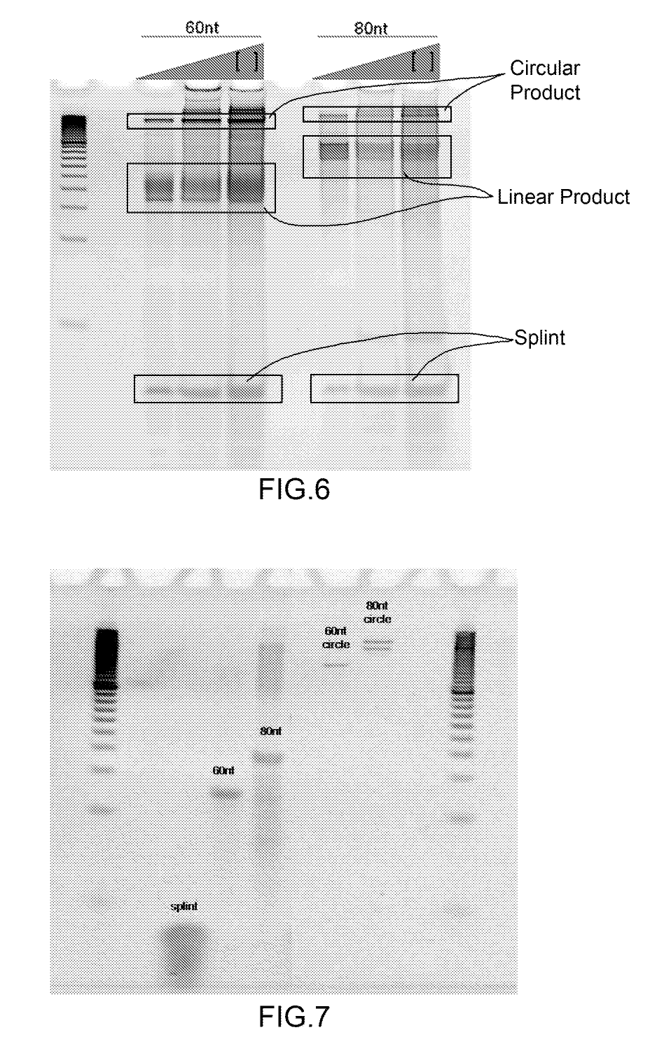

As it evident from FIG. 6, all ligation products clearly, compared to linear controls, show 3 separated bands, corresponding to the dehybridized splint, the unreacted linear precursor and the circle; these bands are evident for both lengths and DNA concentration used.

It seems that 4-6 μM between linear precursor and splint is the optimal starting concentration to have an high yield of circle compared to the unreacted linear precursor; this is more evident for 60 nt linear precursor. Furthermore, using this concentration bands corresponding to secondary products (due to the concatameric bond among several linear precursors) are not present.

The sample's collection after purification is not affected by the ethanol precipitation, allowing also to concentrate the reaction product.

Circles from both 60 nt and 80 nt linear precursor have been extracted and purified from the polyacrylamide gel using the crash-soak method:
using a needle, a hole in the bottom of the 0.2 mL microcentrifuge tube containing the gel slices, has been made;
this tube, placed in a larger 0.5 mL tube, has been centrifuged at 14,000 rpm for 2 minutes, until the entire gel slice is collected in the lower tube;
the gel slurry has been covered by 0.3 M ammonium acetate and incubated with shaking for 2 hours;
after elution, the tubes have been spinned at 14,000 rpm for 3-5 min to pellet the gel fragments; the supernatant has been collected and concentrated by EtOH precipitation.

The circle extraction has been evaluated by polyacrylamide TBE-UREA as it shown in FIG. 7.

—Rolling Circle Amplification in Solution—

In order to test the presence of a circular molecule, the ligation products have been used to run a rolling circle amplification in solution, using φ29 polymerase; two 60 nt-sequences, containing the splint (10+10 nt) at the 3′ position and a poliT/A tail (40 nt) have been tested as primers for the elongation.

The linear primers (poliT/A 60 nt sequence), at a 200 nM concentration, has been added to the ligase reaction solution, previously purified using BioSpin columns. The mix has been heated at 90° C. for 2 min and cooled down at RT for 30 min, to allow the strand hybridization between primer and circle. The final solution has been prepared adding to the mix φ29 reaction buffer, 10 mM dNTP mix and 0.4 U/μl enzyme.

The amplification has been carried out at 30° C. and different reaction times, ranging from 1 min to 3 hours.

The following Table 3 and FIG. 8 summarize respectively the experimental conditions and results:

TABLE 3

| | | | | reaction |
|---|---|---|---|---|
| | Template [ ] | dNTP [ ] | φ29 [ ] | time |
| | poliT 5 μM | | | |
| | poliA 5 μM | | | |
| 80 mer ligation | | | | |
| product (200 nM) | | | | |
| 80 mer ligation | | | 0.4 | |
| product (200 nM) | | | U/μl | |
| 80 mer ligation | | | 0.4 | |
| product (200 nM) | | | U/μl | |
| 80 mer ligation | | 10 mM | 0.4 | |
| product (200 nM) | | | U/μl | |
| 80 mer ligation | | 10 mM | 0.4 | |
| product (200 nM) | | | U/μl | |
| 80 mer ligation | | 10 mM | 0.4 | |
| product (200 nM) | | | U/μl | |
| 80 mer ligation | | 10 mM | 0.4 | |
| product (200 nM) | | | U/μl | |
| 80 mer ligation | poliT (200 nM) | 10 mM | 0.4 | |
| product (200 nM) | | | U/μl | |
| 80 mer ligation | poliT (200 nM) | 10 mM | 0.4 | |
| product (200 nM) | | | U/μl | |
| 80 mer ligation | poliT (200 nM) | 10 mM | 0.4 | |
| product (200 nM) | | | U/μl | |
| 80 mer ligation | poliT (200 nM) | 10 mM | 0.4 | |
| product (200 nM) | | | U/μl | |
| 80 mer ligation | poliT (200 nM) | 10 mM | 0.4 | |
| product (200 nM) | | | U/μl | |
| 80 mer ligation | poliA (200 nM) | 10 mM | 0.4 | |
| product (200 nM) | | | U/μl | |
| 80 mer ligation | poliA (200 nM) | 10 mM | 0.4 | |
| product (200 nM) | | | U/μl | |
| 80 mer ligation | poliA (200 nM) | 10 mM | 0.4 | |
| product (200 nM) | | | U/μl | |
| 80 mer ligation | poliA (200 nM) | 10 mM | 0.4 | |
| product (200 nM) | | | U/μl | |
| 80 mer ligation | poliA (200 nM) | 10 mM | 0.4 | |
| product (200 nM) | | | U/μl | |

As shown in the FIG. 8, the φ29 elongation gave amplification products using both splint only or poliT/A primers. The highest yield has been reached after 3 hours reaction (lanes 12-19-24); this is even evident for RCA using 20 nt-splint as primer (lane 12). The highest yield has been reached after 1-3 hours reactions. In all lanes circle, poliT/A primers and 80 nt uncircularized DNA (derived from ligase reaction) are clearly visible.

In summary, ligation reaction performed using T4 enzyme and “μM” concentration of both linear DNA and splint (ratio 1:1.5) resulted in a clearly visible polyacrilamide band corresponding to the circular product, either using 60 and 80 nt length.

RCA in solution using φ29 polymerase confirmed this results, producing amplification products after 1 hour reaction, even using not-purified ligation products.

—Spotting of Amplified Sequence on Solid Support—

RCA amplified primer sequences, functionalized with primary amines were spotted on a solid support to generate an array of amplified sequences.

The RCA amplified sequences were directly diluted by a factor of 2 in a solution of phosphate buffer 150 mM, betaine 1.5M and glycerol 50% (pH 8.5). Each amplified sequence was placed on a Genetix microtitre plate and spotted at RT and 50% humidity on a Genetix aldehyde slide; After an incubation time of 4 hr the slides were washed and the unreacted aldehydic groups inactivated using NaBH4.

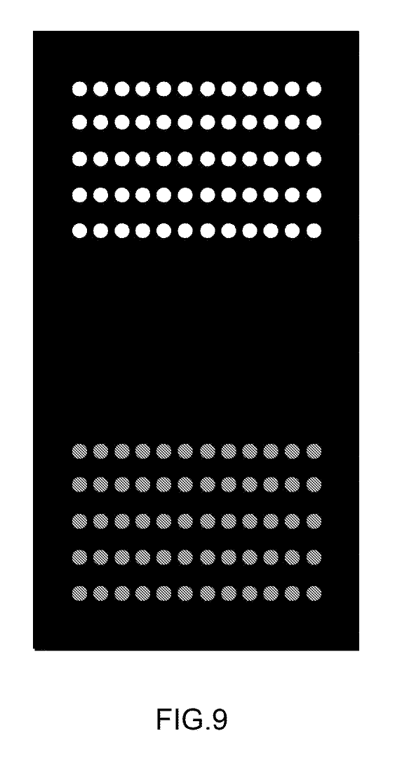

The amplification yield has been evaluated hybridizing the slides with an oligo complementary to the splint sequence, labeled with Alexa647 dye (see FIG. 9). FIG. 9 shows a below plurality of spots consisting of primer sequences not amplified and a above plurality of spots consisting of primer sequences amplified. The below plurality of spots are coloured in grey, whereas the above plurality are white. In this way, it is represented the real difference of luminescence intensity between primer sequences not amplified and primer sequences amplified that has been found in experimental procedure.

RCA in solution using φ29 polymerase confirmed this results, producing amplification products after 1 hour reaction, even using not-purified ligation products.

Such template was then treated as a substrate for the stamping process using the standard procedure used at Molecular Stamping to generate replicas.

—Amplification on Array—

A 60 nt purified circle was used to perform RCA on the array. The same primer sequence of RCA in solution (60 nt poliT) has been used as oligo-template spotted on two aldehyde slides. DNA was diluted in ultrapure water to obtain 100 μM solution and spotted at different concentrations (2-5-10-20 μM) using a solution of phosphate buffer 150 mM, betaine 1.5M and glycerol 50% (pH 8.5). Each DNA concentration has been placed on a Genetix microtitre plate and spotted at RT and 50% humidity on a Genetix aldehyde slide. After an incubation time of 4 hr the slides were washed and the unreacted aldehydic groups inactivated using NaBH4.

Slides have been incubated on Tecan hybstation with a solution containing 60 μl purified 60 nt-circle and 90 μl Nexterion hybridization buffer 1×, to allow the circle hybridization to the spotted strands. The hybridization step has been carried using a temperature gradient: 70° C.-2 min; 50° C.-2 min; 40° C.-2 min; 35° C.-2 min; 30° C.-2 min.

Slides have been washed using SDS 0.1% and decreasing concentrations of SSC, and incubated at 30° C. for 3 h on Tecan hybstation with the following RCA mix:

dNTP mix 5 mM, BSA 1×, φ29 buffer 1×, φ29 polymerase 10 U.

The amplification yield has been evaluated hybridizing the slides with an oligo complementary to the splint sequence, labeled with Alexa647 dye. A spotted slide, not processed with RCA, has been hybridized as control.

The following tables 4 and 5 summarize the results obtained after slide fluorescence scanning using a microarray PERKIN-ELMER (LP 70-PMT voltage 60) and after data normalization for each DNA concentration used for spotting.

TABLE 4

| Spotted DNA | Ctrl | Trt 1 | Trt 2 |
|---|---|---|---|
| 2 μM | 885 | 5696 | 4957 |
| 5 μM | 4798 | 15642 | 16532 |
| 10 μM | 9640 | 27567 | 24973 |
| 20 μM | 17294 | 40661 | 40001 |

TABLE 5

| Spotted DNA | Ctrl | Trt 1 | Trt 2 |
|---|---|---|---|
| 2 μM | 1 | 6.4 | 5.6 |
| 5 μM | 1 | 3.3 | 3.4 |
| 10 μM | 1 | 2.9 | 2.6 |
| 20 μM | 1 | 2.4 | 2.3 |

These results clearly show fluorescence data derived from RCA amplification for both treated slides, compared to the control one. The concentration that shows the highest yield of amplified product is 2 μM, for which treated slides show a fluorescent signal 6 times higher than the untreated one. Such template was then treated as a substrate for the stamping process using the standard procedure used at Molecular Stamping to generate replicas.

The template DNA microarrays obtained according to the method of the present invention may be reused an indefinite number of times for the stamping of DNA microarrays with LHD probes according to the SuNS technique.

As is evident from the above description, coupling of the replication of a rolling circle with the SuNS technique guarantees the preparation of DNA microarrays with LHD probes in an efficient and relatively simple manner.

1. A method for the realisation of DNA microarrays with linear high density probes, comprising a phase of replication of template DNA strands of a template microarray and a subsequent phase of stamping of the molecules obtained by replication on a substrate via the SuNS technique; wherein the template strands of said template microarray are either composed of a rolling circle or derived from a rolling circle.

2. A method for the realisation of DNA microarrays according to claim 1, wherein during replication of the rolling circle, the rolling circle is fixed to a substrate and the replica strand is produced from a promoter strand complementary to a promoter sequence of said rolling circle and comprising a functional group suitable for guaranteeing subsequent fixing of the template strand formed to a surface of a substrate.

3. A method for the realisation of DNA microarrays as claimed in claim 2, wherein said rolling circle is produced by closing of a purposely designed DNA strand, fixed to a substrate and comprising two separate halves of a ligation sequence; closing the DNA strand by the action of a promoter strand which is complementary to the overall ligation sequence and comprises a functional group suitable for guaranteeing subsequent fixing of the replica strand formed to a surface of a substrate.

4. A method for the realisation of DNA microarrays as claimed in claim 3, which comprises producing the DNA strand suitable to be closed for producing the rolling circle by replication of a specifically designed DNA strand, which comprises two halves of a ligation sequence, and subsequently stamped according to the SuNS technique.

5. A method for the realisation of DNA microarrays as claimed in claim 1, wherein during replication of the rolling circle a promoter strand is bonded to a surface of a substrate and is extended via a rolling circle comprising a promoter sequence complementary to the promoter strand.

6. A method for the realisation of DNA microarrays as claimed in claim 1, wherein the replication of the rolling circle through a promoter is done in solution and the product of the extension of the promoter is subsequently bonded to the surface of the substrate to generate the template DNA array.

7. A method for the realisation of DNA microarrays as claimed in claim 5, wherein the template strand is produced by adding a new promoter sequence to a free end of the template strand formed by extension of the promoter strand via replication of the rolling circle.


SEQUENCE LISTING (3 sequences)

SEQ ID NO: 1 - DNA, 80 bp, human
actacattcaatgctccatcgaaagccccacccgcccaaatgtttgtctgtgttccgttgtccgtgctgtcagagtgtac

SEQ ID NO: 2 - DNA, 60 bp, human
actacattcaatgctccatcgaaagccccacccgcccaaatgtttgtctgcagagtgtac

SEQ ID NO: 3 - DNA, 20 bp, human
tgaatgtagtgtacactctg